(19) United States
(12) Patent Application Publication
(10) Pub. No.: US 2007/0119785 A1
(43) Pub. Date: May 31, 2007

(54) Metal mediated aeration for water and wastewater purification

(75) Inventors: James D. Englehardt, Coral Gables, FL (US); David E. Meeroff, Parkland, FL (US)

Correspondence Address: AKERMAN SENTERFITT, P.O. BOX 3188, WEST PALM BEACH, FL, 33402-3188, US

(73) Assignee: UNIVERSITY OF MIAMI, Miami, FL (US)

(21) Appl. No.: 10/590,374

(22) PCT Filed: Oct. 29, 2004
(86) PCT No.: PCT/US04/36212

§ 371 Date: Jan. 5, 2007

Related U.S. Application Data
(60) Provisional application No. 60/515,269, filed on Oct. 29, 2003.

(51) Int. Cl. C02F 1/68

(52) U.S. Cl. 210/749

(57) ABSTRACT

A water or wastewater treatment method includes the steps of providing an Fe source, the Fe source including an Fe salt or relatively high surface area Fe metal arrangement, such as a volume of Fe filings, steel wool, or Fe nanoparticles. The Fe source is contacted with influent water including at least one contaminant or chelating agent bound contaminant in the presence of an oxygen comprising gas flow, such as air. The outlet flow following the contacting step provides a reduction in a concentration of the contaminant and/or chelating agent from its level in the influent through oxidation of the contaminant or precipitation, co-precipitation, or reduction to metal form of the contaminant with the Fe source to form a metal sludge. The method can include a separating step including sedimentation or filtration of the transition metal sludge from the outlet flow.

### FIELD OF THE INVENTION

The invention relates to water and soil purification, more particularly to purification systems and methods based on metal-mediated aeration.

### BACKGROUND

Over six million new chemicals are estimated to have been introduced to the environment by humanity, including 60-95 thousand produced commercially, and another thousand added each year. Many of these chemicals are accumulating in waters and living tissues. While the long-term environmental and health impacts of many of these chemicals are not well understood, some of these compounds are known to cause estrogenic or carcinogenic effects in humans and animals at concentrations found in certain natural waters. Moreover, several recent studies have indicated the universal occurrence of industrial and agricultural chemicals in human blood samples.

Existing chemical processes for oxidizing organics and disinfecting water and wastewater generally use chemical, thermal, or radiant energy as inputs. Chlorination is a common water purification method. However, chlorination imparts emerging chlorinated contaminants. Membrane filtration and adsorption is another common water purification method. However, applications for membrane filtration and adsorption are generally limited because contaminants are transferred to another phase, and thus not destroyed. Advanced oxidation processes are generally capable of efficiently oxidizing organics in water, and include electron beam treatment, Fenton processes (using hydrogen peroxide), UV/titanium dioxide, UV/ozone processes, and simple ozonation. However, these advanced oxidation processes are generally expensive and do not effectively remove inorganic contaminants. Therefore, economical methods for effectively decomposing and removing emerging contaminants including both organic and inorganic contaminants from water, wastewater and solid media, such as sediment, are needed.

### SUMMARY OF THE INVENTION

A water treatment method includes the steps of providing an Fe source, the Fe source comprising an Fe salt or relatively high surface area Fe metal arrangement. As used herein, the phrase “relatively high surface area metal arrangement” refers to a volume of metal which provides a surface area to volume ratio of at least 1×10²/m, and preferably at least 1×10⁶/m. The relatively high surface area arrangements can be a volume of Fe filings, steel wool, or a plurality of Fe nanoparticles. The Fe source is contacted with influent water including at least one contaminant in the presence of an oxygen comprising gas flow, such as air. The contaminant can be in a chelated form. The contacting step can be performed at ambient conditions and exclusive of any externally applied energy sources.

The outlet flow following the contacting step provides a reduction in a concentration of the contaminant from its level in the influent through oxidation of the contaminant and chelating agent (if present) or precipitation, co-precipitation, or reduction to metal form of the contaminant with the Fe source to form a metal sludge. The reduction in contaminant concentration is generally by a factor of at least 10, such as 20, 30, 40, 50, 60, 70, 80, 90 or 100 using exposure times of about 24 hours, or less.

The Fe salt can be a ferrous salt, such as ferrous sulfate or ferrous carbonate. The method can be performed in a pH range of from 5 to 9, thus generally removing the need for a pH adjustment step. When the Fe source is Fe metal, the contacting step preferably includes ultraviolet irradiation.

The method can be performed in a fluidized bed reactor. In this embodiment, the fluidized bed reactor includes at least one magnetic field source, the method comprising the step of magnetically-controlled fluidizing. The method can include the step of separating the outlet flow into treated effluent and the metal sludge using sedimentation or filtration of the metal sludge.

The influent water can comprises chelated metal, such as from a source of industrial wastewater which contains chelated metals. Alternatively, chelated metal can be provided by contacting soil or sediment having metal with a chelating agent to form the chelated metal. The chelating agent can comprise ethylenediaminetetraacetate (EDTA) or an EDTA derivative, such as EDTA Di sodium or EDTA Tetra sodium. In this chelated metal embodiment, the contacting step then generally oxidizes the EDTA. EDTA oxidation can generally efficiently proceed even when the Fe surface area is less than 1×10²/m, such as 1/m.

Although ferrous salts are generally preferred, the Fe salt can be a ferric salt. In one embodiment using a ferric salt, the contacting step includes iron-reducing bacteria for reducing Fe+³ to Fe+².

A water treatment system includes a reaction chamber including an Fe source, the Fe source comprising an Fe salt or relatively high surface area Fe metal arrangement, at least one inlet and at least one outlet. A source of an oxygen comprising gas is provided, the oxygen comprising gas being fluidically connected to the reaction chamber. When influent water including at least one contaminant is contacted with the Fe source in the presence of the oxygen comprising gas, a flow emerging from the outlet provides a reduction in a concentration of the contaminant from its level in the influent through oxidation of the contaminant or precipitation, co-precipitation, or reduction to metal form of the contaminant with the Fe source to form a metal sludge. The reaction chamber can be a fluidized bed. When the Fe source includes Fe metal, said system preferably includes a magnetic field source to permit magnetically-controlled fluidizing. The system can also include an ultraviolet or ultrasonic source.

### BRIEF DESCRIPTION OF THE DRAWINGS

A fuller understanding of the present invention and the features and benefits thereof will be accomplished upon review of the following detailed description together with the accompanying drawings, in which:

FIG. 1 shows one design of an Fe mediated aeration-based water treatment system, according to an embodiment of the invention.

FIG. 2 is a schematic of a system for remediation of dredged sediment, according to another embodiment of the invention.

FIG. 3 is a schematic of a system according to an embodiment of the invention for Fe-mediated aeration/vertical circulation process for removing mixtures of cationic and anionic metals, radionuclides, and organics, from groundwater and soils.

FIG. 4 is a schematic diagram of a bench scale non-energized fixed bed reactor used for certain experiments performed according to the invention.

FIG. 5(a) provides data showing EDTA decomposition versus non-energized treatment time with and without aeration (oxygen), while FIG. 5(b) provides data showing EDTA decomposition versus non-energized treatment time with and without ambient light, according to an embodiment of the invention.

FIG. 6 shows concentrations of a variety of metallic cations and anions initially (influent), and after 25 hours of aeration with filtration (effluent), according to an embodiment of the invention.

FIG. 7(a) shows initial and final metal concentrations of several metals following 25 hours treatment in a non-energized reaction according to the invention, for simultaneous treatment of mixtures of nickel, cadmium, lead and mercury, while FIG. 7(b) shows system performance for simultaneous treatment of mixtures of oxides of arsenic, vanadium and chromium.

FIG. 8(a) shows glyoxylic acid production versus time using a non-energized Fe mediated aeration process according to an embodiment of the invention, while FIG. 8(b) shows removal by oxidation of 1.78 mM EDTA in 24 hours and 48 hours using a non-energized Fe mediated aeration process according to an embodiment of the invention as compared to lack of removal by oxidation, co-precipitation, or other means using aeration in the presence of Fe⁺³ sludge and using aeration alone.

FIG. 9(a) shows removal efficiency in energized reactors including continuous ultrasonic energy, with and without iron, showing the effect of aeration and deaeration, while FIG. 9(b) shows removal efficiency using continuous ultraviolet energy, compared with same reactor operated without energy, according to the invention, according to an embodiment of the invention.

FIG. 10 shows cadmium removal vs. aeration/illumination time in a UV-assisted reactor described as compared to operation of the same reactor without UV illumination, according to an embodiment of the invention.

FIG. 11 shows EDTA removal versus time of catalytic aeration, with and without application of pulsed ultrasonic energy (60 seconds on, 60 seconds off), 94-95 W/cm², in identical reactors, according to an embodiment of the invention.

FIG. 12 shows cadmium removal versus time of catalytic aeration, with and without application of pulsed ultrasonic energy (60 seconds on, 60 seconds off), 94-955 W/cm², in identical reactors, according to an embodiment of the invention.

FIG. 13 shows the removal of 17 β-estradiol and di-n-butyl phthalate from simulated natural water at pH ˜7 with 24 hours aeration, using the invention.

FIG. 14 shows disinfection kinetics using the invention applied to coliform and E. coli bacteria, according to an embodiment of the invention.

FIGS. 15(a)-(c) show the pH, conductivity, and chemical oxygen demand (COD) removal versus treatment time, results obtained when secondary effluent treated municipal wastewater is treated with 65.8 mM ferrous sulfate according to the invention, respectively.

FIGS. 16(a)-(c) show pH, conductivity, and chemical oxygen demand (COD) removal versus treatment time, results obtained using 1 mM of ferrous sulfate according to the invention to treat secondary effluent treated municipal wastewater, respectfully.

FIGS. 17(a)-(c) show pH, conductivity, and chemical oxygen demand (COD) removal versus treatment time, results obtained using 5 mM of ferrous sulfate according to the invention to treat secondary effluent treated municipal wastewater, respectfully.

FIG. 18 shows COD results using 5 mM ferrous carbonate as compared to no air and Fe, and aeration only controls.

### DETAILED DESCRIPTION

A water treatment method includes the steps of providing an Fe source, the Fe source comprising an Fe salt or relatively high surface area Fe metal arrangement, such as a volume of Fe filings, steel wool, or Fe comprising nanoparticles. As used herein, the phrase “water treatment” is meant to be interpreted broadly and includes waste water, drinking water and other water forms having one or more contaminants including hardness (e.g. calcium carbonate) which can benefit from remediation processing. The Fe source is contacted with influent water including at least one contaminant and/or chelating agent in the presence of an oxygen comprising gas flow. The oxygen comprising gas is generally air, but the invention is in no way limited to air. The liquid phase portion of the outlet flow following the contacting step provides a reduction in a concentration of the contaminant which was present in the influent through oxidation, precipitation, co-precipitation, or reduction to metal form of at least a portion of the contaminant with the Fe source to form a metal sludge. When present, chelating agents, generally in the form of chelated metals generally oxidize. The method can include one or more separating step such as sedimentation and/or filtration of the metal sludge from the outlet flow.

Fe is generally a preferred metal for use with the invention since Fe is generally inexpensive, non-toxic, and Fe(III) residuals, such as in the form of an Fe sludge, produced by the inventive process are generally filterable. Although the invention is described using Fe metal or Fe cations derived from Fe salts to mediate the oxidation process, it is expected that transition metals having similar electronic structure and ligand affinities to that of Fe will also effectively mediate the oxidation process described herein. For example, cobalt and manganese and some of their associated salts and oxides, may be used to replace or used in addition to the Fe metal or Fe salt.

Fe salts are generally preferred to Fe metal due to cost and some process considerations. The Fe salts are preferably ferrous salts, where the metal is divalent, such as ferrous sulfate and ferrous carbonate. A potential process limitation regarding the use of Fe metal is that metallic Fe is consumed in the process, and the efficiency of Fe usage when Fe metal is the source depends upon mass transfer of pollutant to the transitory oxidizing species generated in the reactor. Regardless of mechanism, it seems apparent that the reaction occurs at the surface of the Fe or other metal mediator. However, the oxidizing species generated can be scavenged (consumed) by the ferrous generated in the process, as well as by natural water alkalinity, before having a chance to oxidize pollutants.

Given the mechanism proposed below, higher iron surface area should promote more rapid and likely a more efficient reaction. In one embodiment, nanoparticles of Fe are used to maximize surface area and to promote iron reactivity. A water soluble form of iron, such as an Fe salt, will produce a higher reactive surface area than even Fe nanoparticles, and likely the greatest efficiency, particularly when strongly chelating organics are present. Highly efficient removal of organics using ferrous sulfate are shown in the Examples.

When embodied as a relatively high surface area Fe metal arrangement, the arrangement preferably provides a relatively high surface area to volume ratio, such as is available from porous or solid metal granules, micro size or nanosize Fe particles, or Fe fibers.

Other forms of Fe may be used with the invention. In particular, although Fe(III) is generally non-reactive with oxygen, ultraviolet light, such as provided by a 450 W medium pressure mercury vapor lamp can convert Fe(III) to Fe(II). Also, organics can be oxidized and, in the process, reduce Fe(III) to Fe(II). Therefore, iron salts, oxides and hydroxides containing Fe(III) can be used as Fe sources with the invention, particularly when used with UV light. Fe(IlI) can also be readily reduced electrochemically on electrodes in an electrolytic solution, such as provided by landfill leachate or industrial wastewater.

Alternatively, ferric (Fe⁺³) could be reduced to ferrous (Fe⁺²) through the use of iron-reducing bacteria. In this embodiment, the bacterial culture would solubilize the iron, allowing the bacterial sludge to be removed by sedimentation/filtration.

In general, iron reducing bacteria prefer lower temperatures but are known to grow at temperatures which range from 0-40° C., with an optimum temperature of 6-25° C. Their pH range for growth will vary from 5.5 to 8.2 with an optimum pH around 6.5. These organisms are not affected by light and have been found to grow in exposed areas, in shade as well as complete darkness.

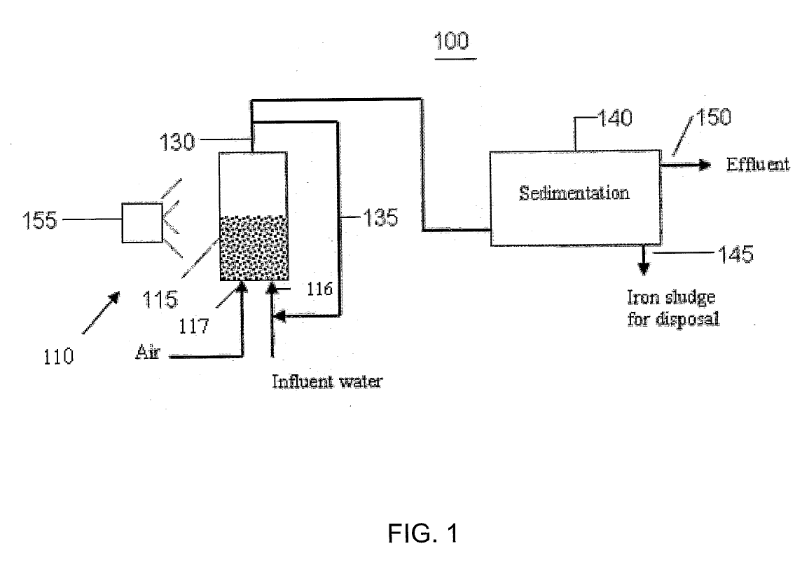

FIG. 1 shows an exemplary metal mediated aeration-based water treatment system 100, according to an embodiment of the invention. The system 100 includes a fluidized bed reactor 110 and a sedimentation filter 140 reactor 110 includes optional UV source 155. Although a fluidized bed reactor 110 is shown in FIG. 1, a standard fixed reactor is generally suitable for use with the invention.

The relatively high surface area metal arrangement shown in reactor 110 is a volume of Fe filings 115. Reactor includes an inlet 116 for receiving influent water including at least one contaminant and another inlet 117 for receiving air. Contaminants can include organic contaminants, inorganic contaminants, as well as microbials, such as protozoa and viruses. Chelating agents are oxidized, organic contaminants are oxidized or co-precipitated, while inorganics and some organics are generally co-precipitated together with Fe to form a sludge. When present, microbials are generally inactivated by reactor 110.

Influent water including contaminant(s) is contacted by the Fe filings 115 in the presence of oxygen provided by air. Air is preferably provided by a continuous flow source. Although H₂O₂ decomposition rates are known to decrease substantially at pH levels >4, the invention has been found to generally efficiently remove contaminants at ambient pH levels, such as 5, 6, 7, 8 or 9. Although pH adjustment is thus generally not required, in certain situation it may be desirable to either raise or lower the pH in reactor 110 to increase the efficiency of the remediation process. In this embodiment, a further step of neutralization (not shown) can performed prior to releasing effluent 150.

A resulting outlet flow 130 from reactor 110 following the contacting step provides a reduction in a concentration of the contaminant as compared to its concentration in the influent and/or oxidation, precipitation, or co-precipitation of at least a portion of the influent contaminant with the metal to form an Fe sludge. Part of the outlet flow 130 is preferably recirculated for additional treatment in reactor 110 through fluid connection 135, to achieve the desired mean residence time in the reactor. Remaining flow is directed to the sedimentation basin 140 for separation of the Fe sludge to provide treated effluent 150.

A sedimentation basin 140 is only one possible embodiment of a separation device for separating the Fe sludge 145 from treated effluent 150. For example, sand filters or membrane filters can be used, with or without pretreatment or sedimentation. Although system 100 includes a separation device embodied as a sedimentation basin 140, in some applications, sedimentation basin 140 will not be needed.

When the Fe metal source is Fe(0) which is paramagnetic such as from Fe filings; the fluidized bed reactor 110 can include a magnetic field source (not shown) so that magnetic separation can be used to retain Fe(0) at the reaction interface, while maximizing mass transfer of Fe(III) away, and bulk solution to, the interface. However, it is believed that physical separation by straining and flow control provided by system 100 will generally provide equivalent separation with less complexity and expenditure of energy as compared to a magnetically fluidized bed reactor.

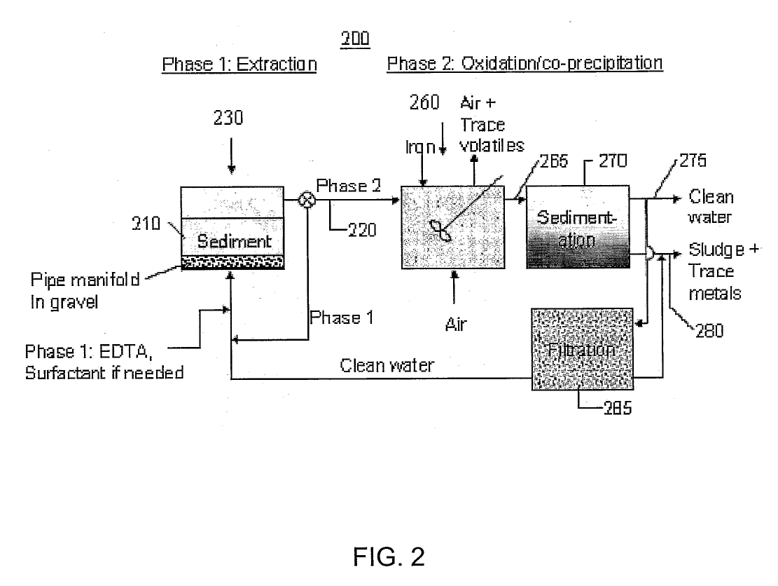

FIG. 2 is a schematic of a system 200 for remediation of dredged sediment, according to an embodiment of the invention. System 200 implements a 2-phase remediation process comprising an extraction phase 230 and an oxidation/co-precipitation phase 260. As shown in FIG. 2, sediment 210 is flushed in an upflow mode to remove organics and metals. If needed, as shown in FIG. 2, EDTA or another other suitable chelating agent is added to extract any cationic contaminant metals in the sediment 210 into the aqueous phase.

The extractant from the extraction phase 220 is then subjected to an oxygen comprising gas (e.g. aerated) in the presence of a natural, mineral catalyst in the oxidation/precipitation/co-precipitation phase of the remediation process. The term “catalyst” is used broadly to refer to an auxiliary reactant that, although being consumed in the reaction, accelerates the primary reaction. A “mineral catalyst” is generally defined herein as a metallic specie, such as Fe in the form of iron filing or steel wool, Fe nanoparticles, or a cationic specie, such as Fe²⁺ provided by ferrous salts. The mineral-mediated aeration in phase 2 oxidizes EDTA and oxidizable organics, and co-precipitates cationic metals, anionic metal oxides and other organics in the water. For example, EDTA has been oxidized, estrogen and n-dibutylphthalate have been removed, and strontium, cadmium, lead, mercury, nickel, arsenate, arsenite, vanadate, and chromate have been found to be removed.

The outlet flow 265 from the oxidation/co-precipitation process is directed to sedimentation filter 270. Sedimentation filter separates clean water 275 from sludge and trace metals 280. Clean water 275 can be output by system 200, or filtered by filter 285 and then sent for one or more additional cycles of remediation processing.

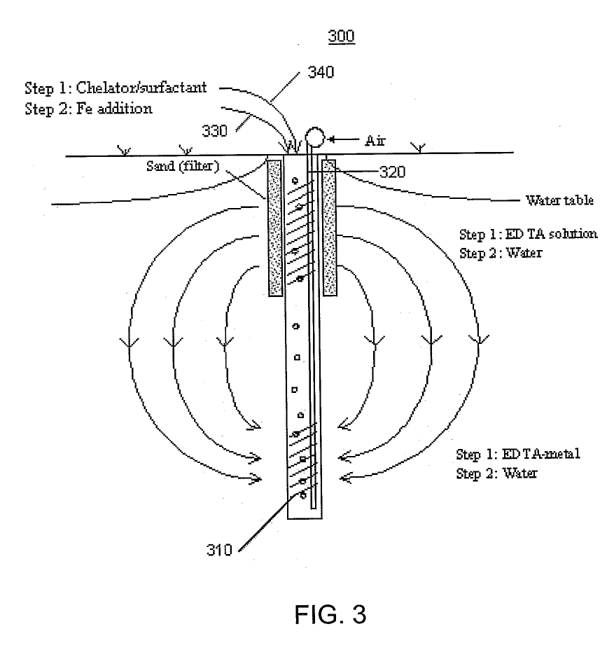

FIG. 3 is a schematic of a system 300 for iron-mediated aeration/vertical recirculation process for removing mixtures of cationic and anionic metals, radionuclides and organics, from groundwater and soils via a well 310. Conduit 320 provides air to the base of well 310. Chelator/surfactant 340 and Fe source 330 are provided by system 300. The chelator EDTA may be used.

The recirculation well-based system 300 shown in FIG. 3 has no moving parts below ground and is capable of running continuously with minimal periodic maintenance. Pumping costs and permitting issues are minimized because groundwater remains below ground. In the first phase of remediation, a chelator 340 such as EDTA is added to the well, to extract and transport divalent and trivalent metal cations to the well 310. Cationic metals and radionuclides present in zero-valent form are oxidized by the continuous aeration provided, and removed. Metallic/radioactive oxyanions are generally mobile in the subsurface, and are transported to the well 310. Circulation with EDTA is continued until the chelating agent is saturated with metal contaminants, and the desired soil concentrations are achieved. Although EDTA oxidative byproducts are biodegradable, EDTA is persistent in the environment and not expected to degrade over the course of the extraction phase. Following extraction, the Fe source 330 is added to the well to (a) mediate the oxidation/co-precipitation of EDTA during aeration, and (b) remove target metals from the water by coagulation and co-precipitation with hydrous ferric oxide, which is sparingly soluble at circumneutral pH (Kₛₚ=10⁻³⁸) and has a large surface area (˜600 m²/g), strong affinity for contaminant metals, and rapid metal adsorption kinetics (hours). Upon leaving the well 310 and returning to the aquifer, circulating water preferably passes through a sand filter layer for removal of residual contaminants and iron. The metal/EDTA removal phase continues until target groundwater concentrations are achieved. Simultaneously, volatiles are removed by stripping, biodegradation is accelerated by aquifer aeration, and relatively general oxidation of organics occurs by the Fe mediated process. An analogous ex-situ process for EDTA extraction and remediation of dredged sediment was described relative to FIG. 2 above.

Although the system 300 shown in FIG. 3 uses EDTA, the addition of a chelator such as EDTA is not generally required by the inventive process. The ability of the inventive process to remove metal oxyanionic contaminants without using EDTA can significantly reduce the cost of the process.

Using systems according to the invention, organics, including bio-toxics, in both water and wastewater can be oxidized at rates of at least that of conventional activated sludge treatment. Treatable organics also include di-n-butyl phthalate, NDMA, pesticides, and pharmaceuticals. Because the principal oxidants are thought to be hydroxyl radical and/or ferryl/perferryl ions, it is likely that oxidation of organics will be indiscriminant. For example, if EDTA were added to a mixture of organics and treated using iron mediated aeration according the invention, it is likely that the whole mixture would be indiscriminately oxidized. Byproducts produced by the metal mediated aerobic oxidation process will generally include CO₂ and, depending on time of treatment, relatively simple, biodegradable organics.

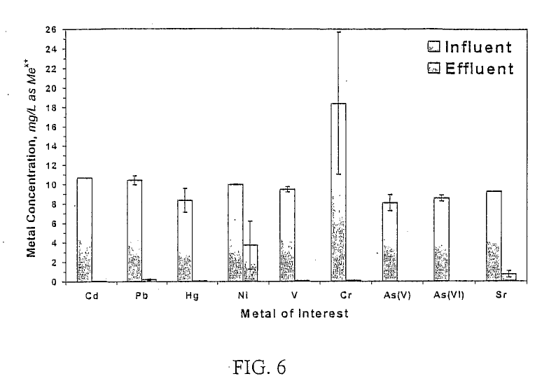

The inventive process also removes inorganics by metal-mediated aeration. For example, treatable inorganics include arsenite, arsenate, mercury, chromate, nickel, lead, cadmium, vanadate, strontium, nitrate, phosphate, perchlorate, and radionuclides (See FIG. 6 and accompanying description).

Further, the process can be used for the disinfection of water, potentially including cellular organisms (e.g. protozoans) and RNA (e.g. viruses). Thus, systems according to the invention can eliminate the formation of chlorinated byproducts such as nitroso-dimethylamine (NDMA, a potent carcinogen) generated by conventional chlorination processing. Perchlorate may also be removed using the invention based on preliminary results obtained for oxidic anions.

An additional benefit of the inventive process is that the process, while oxidizing organics and co-precipitating metals, also softens the water by precipitating minerals including calcium carbonate if the process is implemented using metallic Fe. Unlike other metals which are co-precipitated with the Fe provided, calcium metal (hardness) is precipitated due only to the aeration, even in the absence of iron, driven by the need to maintain charge balance in the water. Thus, the total dissolved solids are reduced because calcium and carbonate are the dominant ions in natural fresh waters.

The invention can also generally be applied to solid media. For example, through use of a suitable chelating extraction agent, such as EDTA, solid media including soil and sediment (e.g. dredged sediment). The chelating agent upon contact with a variety of inorganics forms a fluid including complexed contaminants which can be treated using metal mediated aeration according to the invention. EDTA extraction is particularly effective for cationic metals.

Turning now to a comparison of the invention to related art, the superoxide anion radical (O₂.−) is known to react with hydrogen peroxide (H₂O₂) to produce O₂, OH⁻, and a hydroxyl radical (HO.). However, this reaction is known to proceed at a very low rate. In the presence of Fe(II), the Fenton reaction occurs. In the Fenton reaction, Fe(II) is oxidized to Fe(III) by molecular oxygen, superoxide, and peroxide and results in the formation of superoxide, peroxide, and hydroxyl radical, respectively. The hydroxyl radical (HO.) can in turn oxidize Fe(II) to Fe(III). Thus, Fenton systems produce both H₂O₂ and HO.. Both are powerful oxidants, with oxidation power relative to chlorine of about 1.31 for H₂O₂ and 2.06 for hydroxyl radical. The iron-catalyzed formation of HO. from superoxide is favored at low pH (<5.5), and when at least one iron coordination site is open or occupied by a readily dissociable ligand such as water.

In the reactions discussed above, H₂O₂ provides the requisite chemical energy for oxidation. In contrast, the invention can proceed with a non-energized, Fe metal or Fe cation mediated aeration process to oxidize organic pollutants, co-precipitate metals, inactivate coliform, E. Coli, and other bacteria in water and wastewater. The non-energized process has been found to be not strictly catalytic, because oxidation is inhibited or stopped when the Fe source is removed. However, Fe metal or Fe from Fe salts have been found to greatly accelerate the oxidation of organics by molecular oxygen, during aeration.

Although not required to practice the invention, Applicants provide the following proposed mechanisms that they do not seek to be bound, first for an Fe metal source then for a ferrous salt. A Fenton-like sequence, at neutral pH, can be driven by iron corrosion and aeration. That is, Fe(0) is continuously oxidized to Fe(II) and further to sparingly soluble Fe(III). Activation of dioxygen to hydrogen peroxide may proceed via incorporation of oxygen in the Fe(II)-EDTAH complex. Thus, the limiting step in a Fenton-like sequence, the formation of superoxide (O₂⁻) ion, may be eliminated. That is, peroxide may go on react with Fe(II) to generate hydroxyl radical. Higher valence iron species, ferryl and perferryl ions, may also be formed as intermediate or terminal oxidants in the process.

Hydroxyl radicals and hydrogen peroxide thus generated may produce ferryl/perferryl according to the following equations below:
Fe(OH)(H₂O)₅]⁺+H₂O₂→[Fe(OH)(H₂O₂)(H₂O)₄]⁺+H₂O
[Fe(OH)(H₂O₂)(H₂O)₄]⁺→[Fe(OH)₃(H₂O)₄]⁺
The intermediate iron (IV) complex may react further to form free hydroxyl radical and Fe(III):
[Fe(OH)₃(H₂O)₄]⁺+H₂O→[Fe(OH)(H₂O)₅]²⁺+OH⁻+HO^{.}

An alternate mechanism is also possible, in which oxidations are initiated by iron in the form of iron-oxygen (Fe—O) complexes, or hydrated higher-valent iron species. Although the oxidations are started with Fe(II) and O₂, the exact nature of the initiating species is unknown. This high oxidation state chemistry can be described as below, in which the formal charge of iron in perferryl ion is +5:
Fe^{II}+O₂ [symbol] [Fe^{II}—O₂⇄Fe^{III}—O₂^{.-}](Perferryl ion) [symbol] Fe^{III}+O₂^{.-}

Perferryl can then react with Fe^{II} to form ferryl, as follows:
Fe^{II}+Fe^{II}—O₂ [symbol] Fe^{II}—O₂—Fe^{II} [symbol] 2Fe^{II}—O₂

Hydroxyl radical and ferryl moieties not scavenged by ferrous hydroxide or bicarbonate can indiscriminately oxidize organic contaminants. Assuming this mechanism, reactions occur at the Fe(II) interface between the metal and the oxy/hydroxy Fe(III) precipitate. Support for this mechanism are published results reporting solution-phase oxidation in Fenton and EDTA systems. If the process is indeed interfacial, then mass transfer characteristics of reactants, intermediates, and products to, and away from, the interfacial reaction zone will determine rates of organic oxidation and Fe(III) precipitation. However, in other types of advanced oxidation processes involving particulate catalysts, the catalyst with the largest surface area is not always the most active.

If a strong chelating agent such as EDTA is present, it is believed that reaction comprises dioxygen reacting with Fe(II) and the chelating agent to generate hydrogen peroxide, which then produces hydroxyl radicals in a Fenton-like step as follows:
[Fe^{II}(EDTA)(H₂O)]²⁻+H⁺→[Fe^{II}(EDTAH)(H₂O)]⁻
[Fe^{II}(EDTAH)(H₂O)−]⁻+O₂→[Fe^{II}(EDTAH)(O₂)]^{+H}₂O
[Fe^{II}(EDTAH)(O₂)]⁻→[Fe^{III}(EDTAH)(O₂⁻)]⁻
[Fe^{II}(EDTAH)(H₂O)]⁻+[Fe^{III}(EDTAH)(O₂⁻)]⁻→[(EDTAH)Fe^{III}(O₂²⁻)Fe^{III}(EDTAH)]²⁻+H₂O
[(EDTAH)Fe^{III}(O₂²⁻)Fe^{III}(EDTAH)]²⁻+H₂O+2H⁺→2[Fe^{III}(EDTAH)(H₂O)]+H₂O₂
2[Fe^{II}(EDTAH)(H₂O)]⁻H₂O₂+2H⁺→2[Fe^{III}(EDTAH)(H₂O)]+2H₂O
Fe(OH)₂+H₂O₂+H⁺→Fe(OH)₂⁺+HO^{.}+H₂O

Thus, Fe(0) is believed to produce Fe(II) in the case of an Fe metal source, while Fe(II) is directly provided by the ferrous salt upon dissolution, which may sequentially react with EDTA and O₂ to form hydrogen peroxide. Hydrogen peroxide may then react with further Fe(II) to form hydroxyl radicals and/or Fe(III), and higher valence Fe species. The hydroxyl radical is a powerful and indiscriminate oxidant, and ferryl and perferryl ions may have reactivities approaching that level. Furthermore, it has been found that cationic metals and anionic metal oxides (e.g. strontium, cadmium, lead, mercury, nickel, arsenate, arsenite, vanadate, and chromate) are removable from the water, presumably by co-precipitation, precipitation, or reduction to the metallic form.

It is believed that the principal oxidizing species generated are hydroxyl radicals and ferryl/perferryl ions generated as a result of reactions at the Fe(II) interface. Thus, oxidation rates may be enhanced and sludge generation diminished through control of iron surface area in the case of a metalic Fe source, aeration rate, mixing energy, and reactor design. Reaction rates may be accelerated and sludge reduced by maximizing mass transfer and surface area, while retaining metallic iron (Fe⁰) or the Fe salt in the aeration zone, for example through the use of a fluidized bed reactor.

Mixing energy can be controlled using a plurality of process parameters. For example, mixing energy can be changed by changing the oxygen comprising gas flow, the water flow, or the speed of the mixing structure, such as a mixing propeller. Another possible removal mechanism for metals and radionuclides is plating out of the metals and radionuclides on the metal catalyst, such as Fe. Most cationic metals other than sodium, aluminum, magnesium, and zinc can be reduced (e.g. Cd⁺⁺ to Cd metal) by Fe metal which would be oxidized to Fe⁺⁺. In the aerated process where the iron surface is covered with hydroxide precipitate, particularly at low pH where the hydroxide sludge generally does not form, this mechanism can become significant along with co-precipitation and precipitation as possible removal mechanisms.

Although generally not required, reaction kinetics can be accelerated further by adding an externally supplied energy source. For example, as shown in the Examples, ultraviolet and ultrasonic energy have been demonstrated to improve process efficiency in tests performed. Ultraviolet energy can reduce sludge generation by reducing Fe⁺³ to Fe⁺². In addition, electromagnetic energy other than UV, such as RF which can be useful for heating water, can be used to increase reaction kinetics.

Iron consumption and sludge generation may be reduced. As noted above, Fe (or other oxygen mediating metals) can be recycled during the process through the use of ultraviolet energy to reduce iron from the ferrous to ferric form, so that it may react again with oxygen to produce reactive oxidant species. Ultraviolet energy is inexpensive to provide and is easily adapted to the inventive process, accelerating the oxidation process considerably while reducing sludge production and iron consumption. The use of ultraviolet energy is estimated to reduce the cost of the use of steel wool to $1/1000 gallons, while providing softening in addition to organics oxidation, metal co-precipitation, and disinfection.

The invention may have a wide range of applications since it can destroy organic contaminants in water and wastewater by simple aeration in the presence of iron, Fe, or Fe cations and remove metals, radionuclides, and other inorganics from water and wastewater by producing an iron sludge. Applications may include water and wastewater utilities, particularly in light of recent and potential new regulation of disinfection byproducts, and recent regulation of arsenic in drinking water, and potential regulation of endocrine disrupting compounds (EDCs) in wastewater. The invention can also be applied to industrial wastewater treatment, such as for textiles, pulp and paper processing. For example, many industrial wastewaters contain chelated metals that are not easily removed by precipitation, but would be readily removed by application of the invention. The invention will have application to water treatment in developing countries, including addressing arsenic poisoning and cholera epidemics. Residential point-of-use drinking water systems can also be based on the invention. In addition, as noted above, through use of chelating agents the invention can also be used to treat solid media, such as soils and dredged sediment.

### EXAMPLES

The present invention is further illustrated by the following specific Examples, which should not be construed as limiting the scope or content of the invention in any way.

Fe Metal Test Results

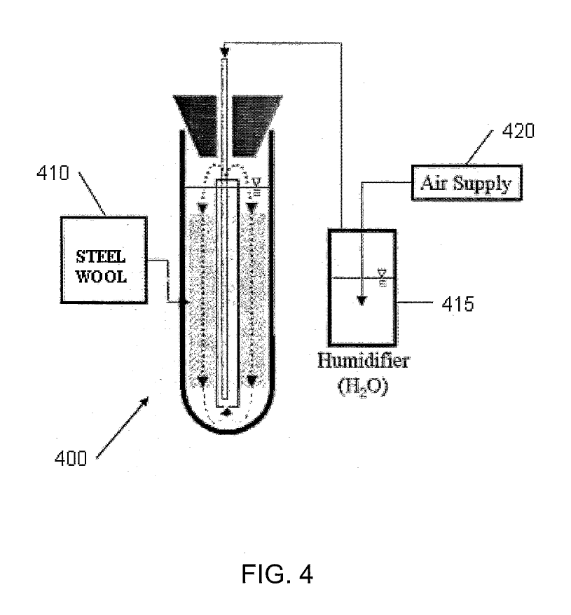

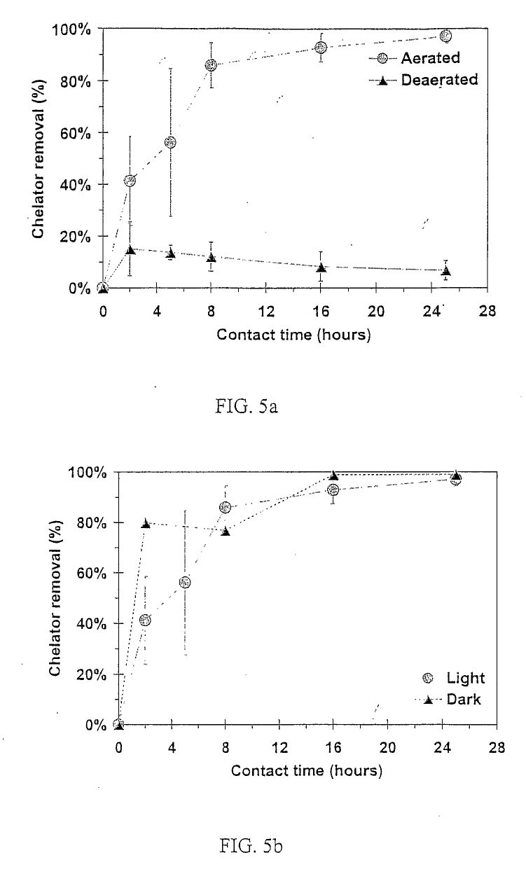

In preliminary laboratory tests, water-metal-EDTA solutions were continuously aerated and circulated through an Fe metal source comprising steel wool 410 for 24 hours, using the bench scale non-energized fixed bed reactor 400 shown in FIG. 4 reactor 400 included humidifer 415 and air supply 420. FIG. 5(a) shows EDTA decomposition versus non-energized treatment time with and without oxygen, while FIG. 5(b) shows EDTA decomposition versus non-energized treatment time with and without ambient light using system 400. The samples contained 0.89 mM Cd²⁺ in simulated “natural” water (0.5 mM CaCl₂ and 3.28 mM NaHCO₃ (200 mg/L HCO⁻) adjusted to pH 7.5-7.6 with concentrated HCl) and 1.78 mM (516 mg/L) of EDTA⁴⁻. Three replicate samples were circulated in the reactor with aeration for 2 hr, 5 hr, 8 hr, 16 hr, and 25 hr intervals.

FIG. 6 shows concentrations of a variety of metallic cations and anions initially, and after 25 hours aeration with filtration using system 400. Results shown are the mean of three replicate samples with +1 standard deviation shown. 10-20 mg/L of each metal was added to two times the stoichiometric amount of EDTA for complexation, in simulated natural water, and tested using procedure described above relative to FIGS. 5(a) and 5(b).

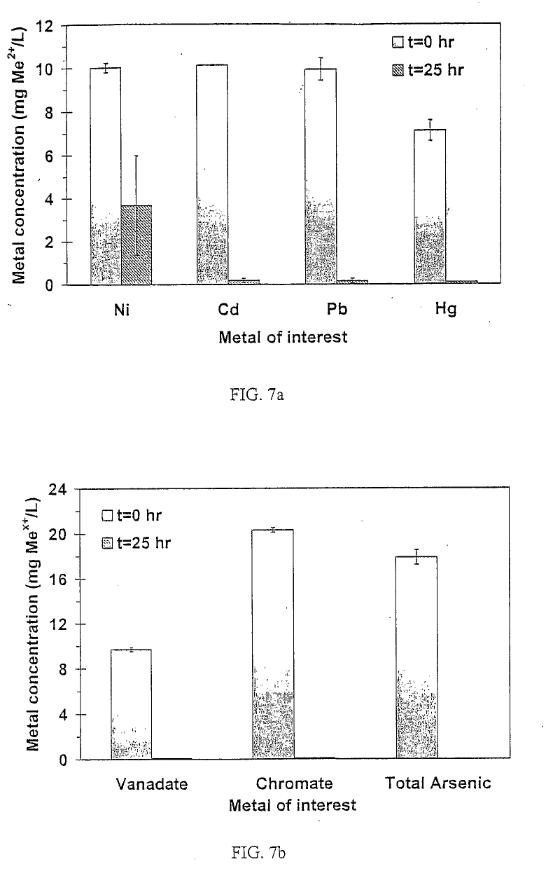

FIG. 7(a) shows the initial and final metal concentrations of metals following 25 hours treatment in a non-energized reactor 400 according to the invention, for simultaneous treatment of mixtures of nickel, cadmium, lead and mercury, while FIG. 7(b) shows system performance for simultaneous treatment of mixtures oxides of arsenic, vanadium and chromium. 10 mg/L of each cationic metal was added as Hg (from HgCl₂), Ni (from NiCl₂.6H₂O), Pb (from Pb(NO₃)₂), and Cd (from CdCl₂) with two times the stoichiometric amount of EDTA for complexation, in synthetic “natural” water, and tested using procedure described relative to FIGS. 5(a) and 5(b). Approximately 10-20 mg/L of each anionic metal was added as K₂CrO₄, NaO₃V, Na₂HAsO₄, and NaAsO₂ without EDTA, in synthetic “natural” water. Results shown are the mean of four replicate samples ±1 standard deviation.

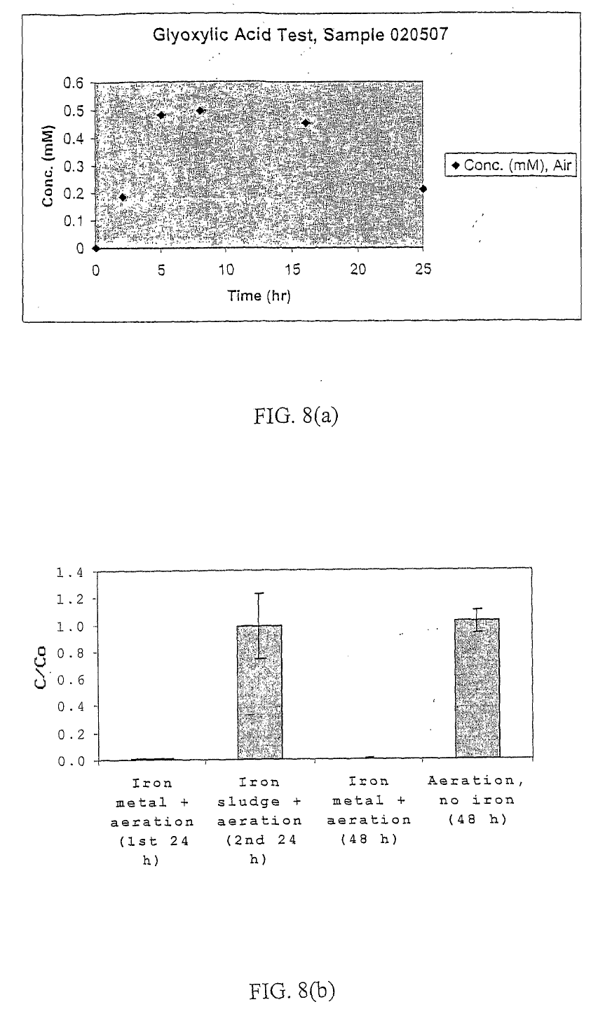

Preliminary analyses of EDTA decomposition byproducts in initial process tests described here indicated that after 25 hours the EDTA may have been largely mineralized to CO₂ and converted to simple, naturally occurring, rapidly biodegradable organic byproducts that may be removed with minor process adjustment. Specifically, as shown in FIG. 8, after 25 hours of treatment, 0.21 mM glyoxylic acid, 0.15 formaldehyde, and 0.02 mM EDTA from the concentration disclosed relative to FIGS. 5(a) and 5(b) remained, accounting for 3%, 2%, and 2% of the original EDTA mass, respectively. The percentages for glyoxylic acid and formaldehyde noted assume that each EDTA molecule is decomposed to four glyoxylic acid or formaldehyde molecules. If significant ED3A (an impurity in EDTA) or related compounds remain after 24 hours, the percentages listed could be up to four times as high, though this is not considered likely based on qualitative analyses of large molecular weight byproducts. Natural formaldehyde is present in raw food, and it is a normal metabolite in the human body. Formaldehyde is permitted as an indirect food additive and is used in mouthwash, toothpaste, and foot powder. Formaldehyde has a half-life of 2-20 days in water.

Minor amounts of iminodiacetic acid and ED3A were detected, both having no known health effects. Some samples contained traces of nitrilotriacetic acid, readily biodegradable and not regulated. Simple organic acids (e.g., acetic, oxalic, formic, malonic) were expected, but not found, in high-pressure liquid chromatographic (HPLC) results, suggesting possible mineralization or co-precipitation. However, chromatographic parameters can be refined further to target such potential byproducts. Nitrate-nitrogen was not detectable at the 1.0 mM level after 301 minutes of non-energized treatment of a Cd-EDTA sample, and nitrite would not be expected under oxidizing conditions.

Results of an experiment to determine the catalytic nature of the reaction are shown in FIG. 8(b). In this experiment, a 1.78 mM EDTA solution was treated in the steel wool aeration reactor for 24 hours. Following 24 hours of aeration, the reactor was agitated and the steel wool was removed, leaving iron in the form of ferric sludge. EDTA was then added to bring the average concentration to 3.24 mM. Finally, samples were aerated for an additional 24 hours. EDTA removal was measured after the initial 24 hour treatment, and again after the second 24 hour treatment period. Control samples were treated for 48 hours (a) with steel wool and aeration, and (b) with aeration only. As shown in the FIG., essentially complete EDTA removal was shown in the samples treated with steel wool and aeration. However, little or no removal was observed in the control samples comprising aeration in the presence of ferric sludge alone, and in the non-iron mediated, aerated sample. Therefore, partitioning of EDTA to the sludge phase was ruled out as a mechanism, given that no removal due to re-equilibration with the sludge phase was observed after 24 hours in the samples brought to 3.24 mM (twice their original concentration). Likewise, volatilization was not observed. Therefore, removal was attributed to oxidation.

Tests have also been conducted with ultrasonic and ultraviolet-energized, iron-mediated aeration reactors. Because the reactor designs were modified somewhat to accommodate the additional equipment, non-energized tests were repeated in the modified reactors for comparison with energized results. Non-energized removals in the modified laboratory reactors were somewhat lower that in the original non-energized reactors, presumably due to altered mass transfer characteristics.

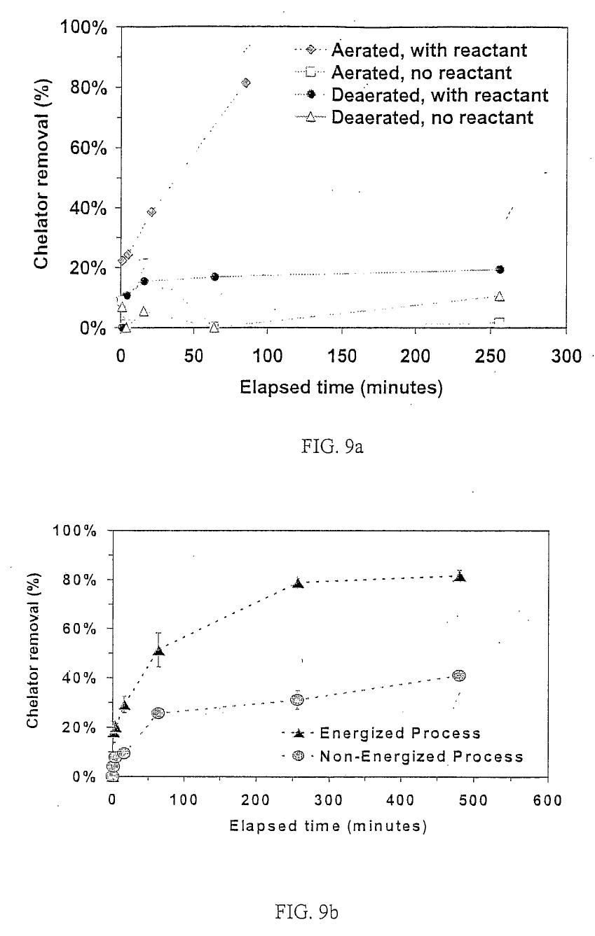

FIG. 9(a) shows removal efficiency in energized reactors including continuous ultrasonic energy, with and without Fe metal, showing the effect of aeration and deaeration, while FIG. 9(b) shows removal efficiency using continuous ultraviolet energy, compared with same reactor operated without energy. Conditions were otherwise the same as described relative to FIGS. 5(a) and 5(b). The ultrasonic energy was 94-98 W/cm² ultrasonic energy, while the ultraviolet energy was provided by a 450-Watt medium pressure, quartz mercury vapor UV lamp. As shown in FIGS. 9(a) and 9(b), removal rates were doubled using ultraviolet energy, and quadrupled using continuous ultrasonic energy as compared to the results shown in FIGS. 5(a) and 5(b), which did not include an external energy source. Removal using pulsed ultrasonic energy (not shown here) was up to twice as high as in non-energized tests. No measurable differences in the byproducts of the UV and ultrasonic-energized processes were found as compared with the non-energized process.

FIG. 10 shows cadmium removal vs. aeration/illumination time in the UV-assisted reactor described above, as compared to operation of the same reactor without UV illumination. UV illumination can be seen to significantly increase the rate of cadmium removal.

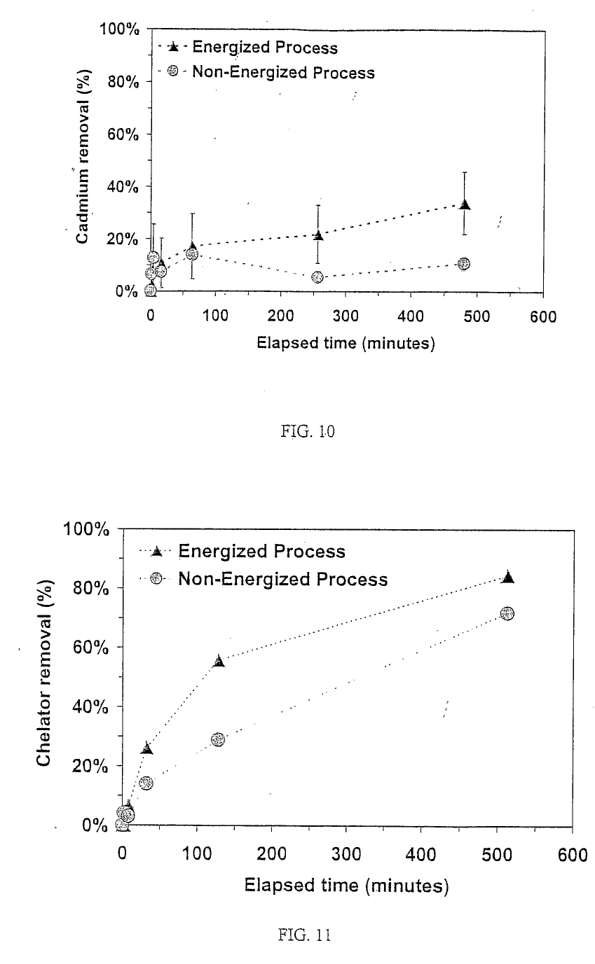

FIG. 11 shows the chelator EDTA removal versus time of catalytic aeration, with and without application of pulsed ultrasonic energy (60 seconds on, 60 seconds off), 94-95 W/cm², in identical reactors. Ultrasonic energy can be seen to significantly increase the oxidation rate of EDTA.

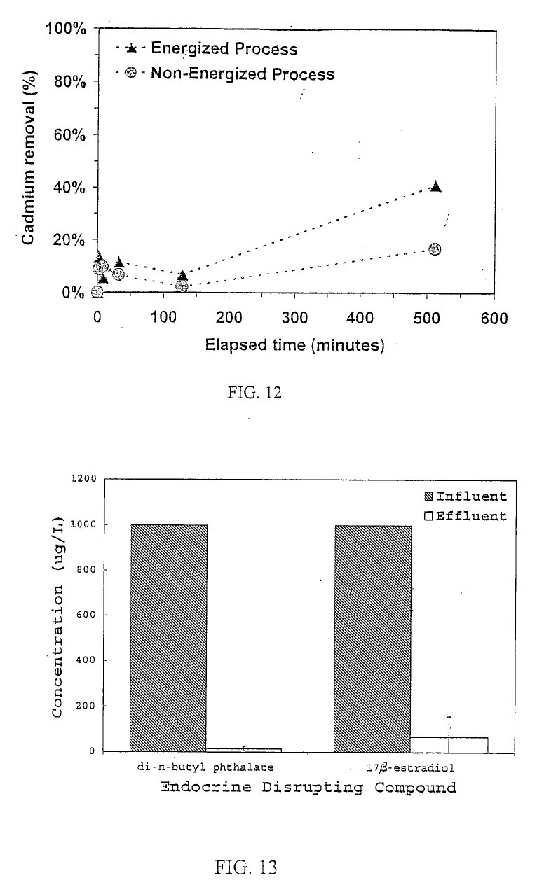

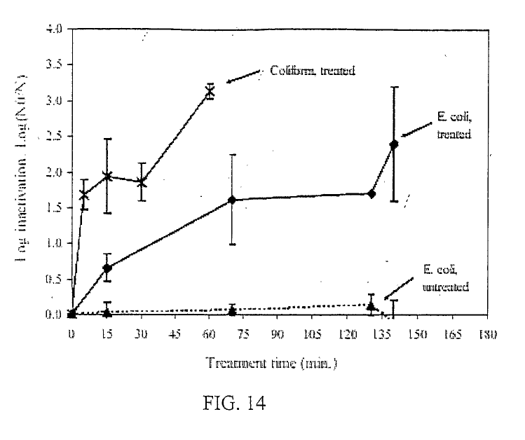

FIG. 12 shows cadmium removal versus time of catalytic aeration, with and without application of pulsed ultrasonic energy (60 seconds on, 60 seconds off), 94-955 W/cm², in identical reactors. Ultrasonic energy can be seen to significantly increase the oxidation rate of EDTA.

FIG. 13 shows removal of 17-βestradiol and di-n-butyl phthalate from simulated natural water at pH ˜7 with 24 hours aeration using reactor 400. The test procedure as described relative to FIGS. 5(a) and 5(b) were used, with analysis by LC-MS. Analysis of phthalate was in terms of phthalate ion, and no other significant phthalate species were observed.

The disinfection kinetics of the inventive process was studied. As shown in FIG. 13, three logs removal of total coliform bacteria were achieved in one hour, a rate of disinfection equivalent to a total residual of 0.7 mg/L chlorine in secondary effluent. This rate can be enhanced significantly, for example in a fluidized bed reactor.

The goal in the experiments summarized herein was to maximize oxidation without regard for iron sludge production. Total iron concentrations obtained after acidification of the unfiltered solution following aeration were on the order of 800-2500 mg/L after 8 hours, one to two orders of magnitude higher than in conventional coagulation systems. However, those iron concentrations likely included broken steel wool particles that will not be present in a continuous-flow, optimized process. Generation of one mole of hydroxyl radical and three moles of Fe(III) per mole of organic in secondary effluent, assuming a number-average molecular weight for organics in secondary effluent of 1242 Daltons, would require generation of about 14 mg/L Fe₂O₃/L secondary effluent. Theoretical minimum sludge mass would be lower still in water treatment applications. As noted earlier, if needed to reduce sludge or accelerate oxidation, ultraviolet energy can be used to convert Fe(III) back to Fe(II), making the process catalytic. However, test results have indicated that the non-energized process may be preferred in a variety of applications due to operational simplicity, efficiency, and stability.

Fe Salt Test Results

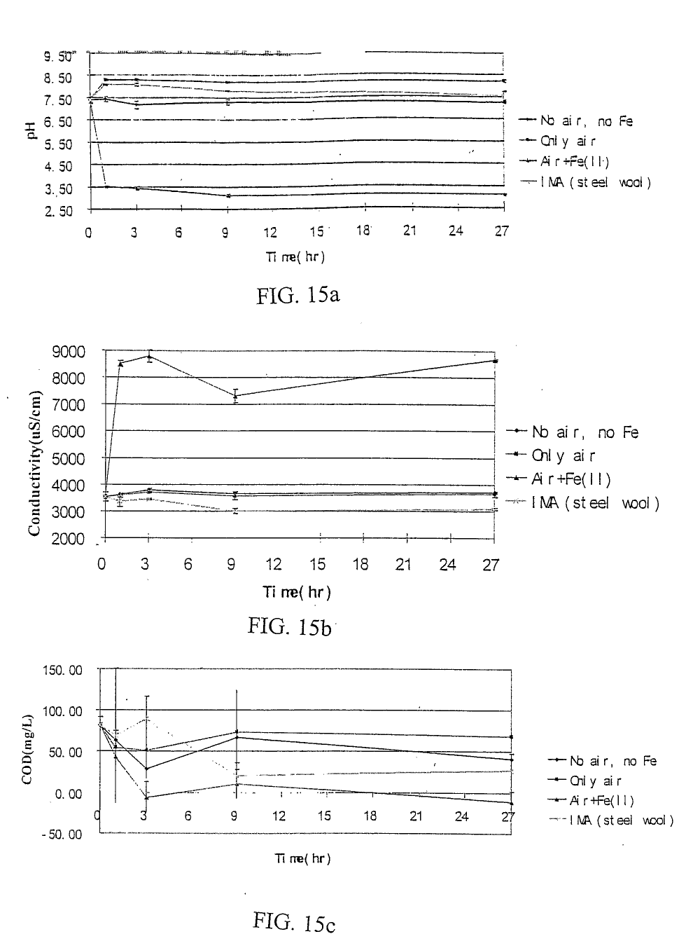

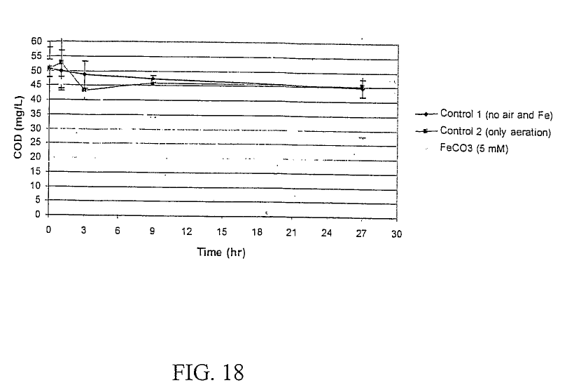

FIGS. 15(a)-(c) through FIG. 18 shows results using and Fe source comprising an Fe salt. FIGS. 15(a)-(c), respectively, show the pH, conductivity, and chemical oxygen demand (COD) removal versus treatment time, when secondary effluent treated municipal wastewater obtained from the Miami-Dade County Virginia Key wastewater treatment facility is aerated with 10000 mg/L (65.8 mM) ferrous sulfate (added at time=0). This data is shown under the title “air & FeII”. Ferrous sulfate once dissolved provided Fe⁺². This concentration of iron is similar to the level of iron consumed in tests using steel wool. The entry titled IMA (steel wool) includes comparative data using Fe metal in the form of steel wool, as well as no air, no Fe and air only controls. Conductivity is a measure of the total dissolved salts, and chemical oxygen demand is a measure of chemically-oxidizable (most) organics. As shown in FIG. 15(c), COD was removed almost completely within three hours, as compared to 9 hours using the steel wool.

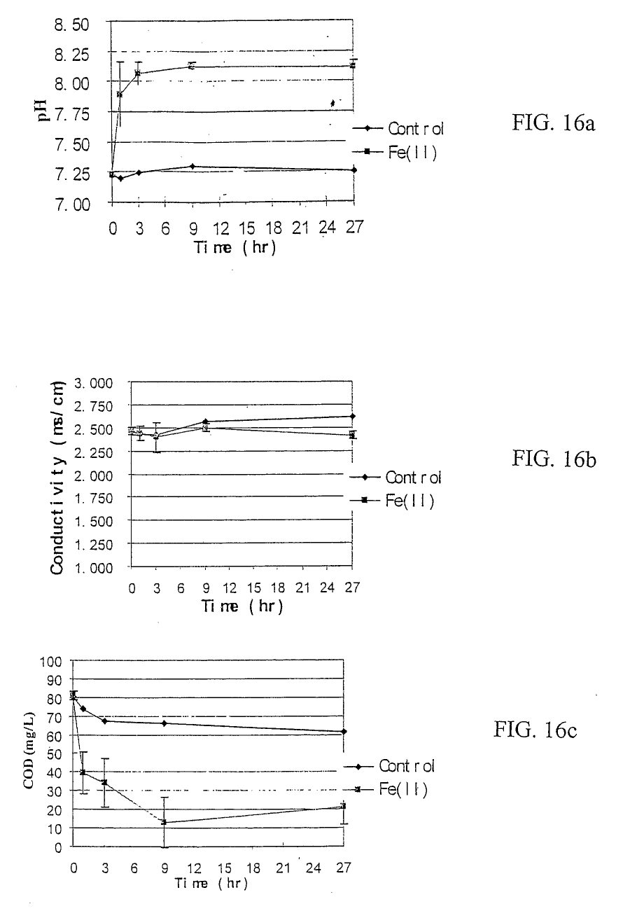

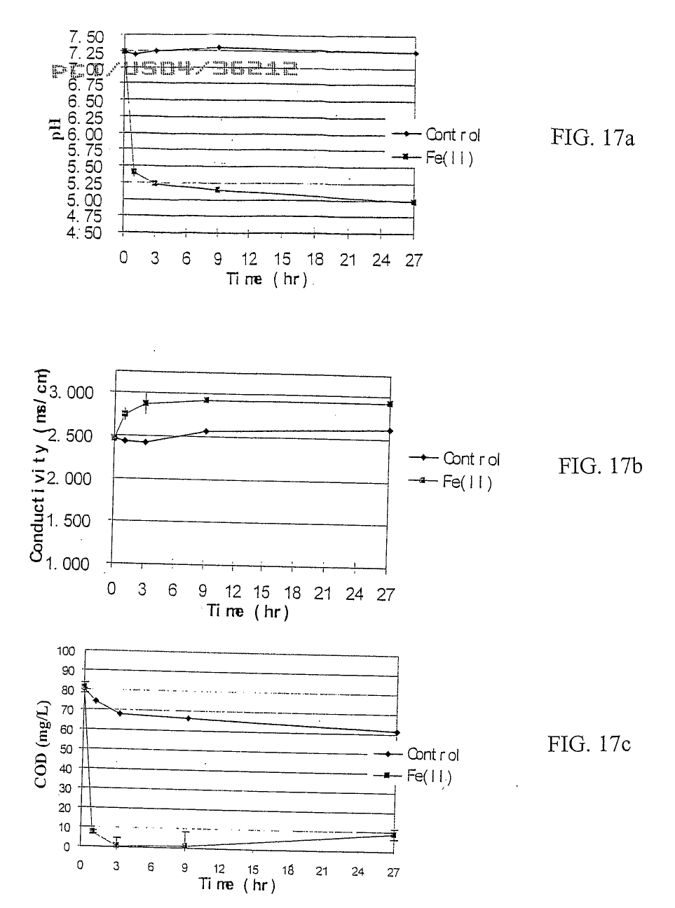

FIGS. 16(a)-(c) and 17(a)-(c) show experimental results obtained from using 1 and 5 mM, respectfully, of ferrous sulfate to treat secondary effluent as compared to the 65.8 mM used to obtain the data shown in FIGS. 15(a)-(c). Control samples contained no iron and were not aerated. As shown by FIGS. 16(a)-(c) and 17(a)-(c), respectfully, the addition of either 1 or 5 milli-molar (mM) of ferrous sulfate resulted in extremely efficient removal, with a minor effect on pH and total dissolved solids. Ferrous sulfate can also remove metals as well as oxidize organics, and disinfect the water for under $1/1000 gallons. The potential minor disadvantage of ferrous sulfate use is that, at high doses, the pH is depressed and dissolved solids are either increased or at least not decreased due to aeration softening. Both effects are due to the sulfate that remains in the water.

The potential, slight disadvantage of using ferrous sulfate, of conductivity and pH, may be avoided by using other ferrous salts, such as ferrous carbonate. The result may be a treatment process capable of effectively converting wastewater treatment plant effluent into drinking water for $0.10-1.00/1000 gallons. That is, the process may remove metals, oxidize organics, soften water, and disinfect pathogens (potentially avoiding the carcinogenic byproducts now formed in disinfection). The process may also serve as a general protection against terrorist events related to treated water. The basis for this action is that ferrous carbonate is a soluble mineral that, in the presence of aeration, reaches equilibrium with CO₂ in the air. That is, excess carbonate reacts to form bicarbonate and then aqueous CO₂, which is stripped to the air. At the same time, under aeration Fe(II) is almost completely oxidized and precipitated to Fe(OH)₃. Thus, the final pH and conductivity of a ferrous carbonate-treated effluent should be the same as if iron metal had been used (pH just above 8). Moreover, ferrous carbonate is generally cheaper per pound of iron than either iron metal ($1/lb. granular; 3/lb. wool; projected $20/lb. nanoparticles) or ferrous sulfate ($0.7/lb.).

Experimental COD results using 5 mM ferrous carbonate are shown in FIG. 18 as compared to no air and Fe and aeration only controls. As shown, almost 50% of the COD was removed in 27 hours using 5 mM ferrous carbonate. While pH was the same as when iron metal was used (about 8.3), as predicted, calcium concentration remained essentially constant and conductivity was reduced only slightly. The reason for the lack of softening appears to be related to calcium impurity in the ferrous carbonate mineral sample, although typical calcium levels for the mineral reported by the manufacturer would not account for this effect. Because ferrous carbonate is not highly soluble in water, it is likely that the rate of COD removal by the ferrous carbonate process can be raised to that of the ferrous sulfate and iron metal mediated processes by increasing the mixing energy in the reactor. This may be possible by simple mixing, or by the addition of ultrasonic or ultraviolet energy. Addition of ultrasonic energy to the steel wool-mediated process was discussed above. The advantage of the ferrous carbonate process is that the effluent may be softened. In any case, the results shown in FIG. 18 demonstrates that a ferrous carbonate based reactor works well, and is competitive in terms of inventive performance and economics as the invention embodied using other forms of iron.

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

We claim:

1. A water or wastewater treatment method, comprising the steps of:
providing an Fe source, said Fe source comprising an Fe salt or a relatively high surface area Fe metal arrangement, and
contacting influent water including at least one contaminant with said Fe source in the presence of an oxygen comprising gas flow, wherein an outlet flow following said contacting step provides a reduction in a concentration of said contaminant from its level in said influent through oxidation of said contaminant or precipitation, co-precipitation, or reduction to metal form of said contaminant with said Fe source to form a metal sludge.

2. The method of claim 1, wherein said Fe salt comprises a ferrous salt.

3. The method of claim 1, wherein said Fe salt comprises ferrous sulfate or ferrous carbonate.

4. The method of claim 1, wherein said method is performed in a pH range of from 5 to 9.

5. The method of claim 1, wherein said Fe source is said Fe metal, said contacting step including ultraviolet irradiation.

6. The method of claim 1, wherein said method is performed in a fluidized bed reactor.

7. The method of claim 6, wherein said fluidized bed reactor includes at least one magnetic field source, further comprising the step of magnetically-controlled fluidizing.

8. The method of claim 1, further comprising the step of separating said outlet flow into treated effluent and said metal sludge, wherein said separating step comprises sedimentation or filtration of said metal sludge.

9. The method of claim 1, wherein said influent water includes chelated metal.

10. The method of claim 9, further comprising the step of contacting soil or sediment having metal with a chelating agent to form said chelated metal.

11. The method of claim 10, wherein said chelating agent comprises ethylenediaminetetraacetate (EDTA) or an EDTA derivative.

12. The method of claim 1, wherein said contacting step is performed at ambient conditions and exclusive of any externally applied energy sources.

13. The method of claim 1, wherein said relatively high surface area Fe metal arrangement comprises Fe filings, steel wool or Fe comprising granules.

14. The method of claim 1, wherein said Fe salt is a ferric salt, said contacting step including iron-reducing bacteria for reducing Fe⁺³ to Fe⁺².

15. A water treatment system, comprising:
a reaction chamber including an Fe source, said Fe source comprising an Fe salt or relatively high surface area Fe metal arrangement, at least one inlet and at least one outlet, and
a source of an oxygen comprising gas, said oxygen comprising gas fluidically connected to said reaction chamber,
wherein when influent water including at least one contaminant is contacted with said Fe source in the presence of said oxygen comprising gas, a flow emerging from said outlet provides a reduction in a concentration of said contaminant from its level in said influent through oxidation of said contaminant or precipitation, co-precipitation, or reduction to metal form of said contaminant with said Fe source to form a metal sludge.

16. The system of claim 15, wherein said reaction chamber is a fluidized bed.

17. The system of claim 15, wherein said Fe source includes Fe metal, said system including magnetic field source.

18. The system of claim 15, wherein said Fe salt comprises a ferrous salt.

19. The system of claim 18, wherein said Fe salt comprises ferrous sulfate or ferrous carbonate.

20. The system of claim 15, further comprising an ultraviolet or ultrasonic source.
